(19) United States
(12) Patent Application Publication
(10) Pub. No.: US 2006/0215727 A1
(43) Pub. Date: Sep. 28, 2006

(54) Integrated heating ventilating and air conditioning generator

(76) Inventor: Charles R. Hampton, Humboldt, TN (US)

Correspondence Address: THE BLACK & DECKER CORPORATION, 701 EAST JOPPA ROAD, TW199, TOWSON, MD, 21286, US

(21) Appl. No.: 11/333,755

(22) Filed: Jan. 17, 2006

Related U.S. Application Data
(63) Continuation of application No. 11/141,264, filed on May 31, 2005.
(60) Provisional application No. 60/575,352, filed on May 28, 2004.

(51) Int. Cl. G01M 1/38; H02P 9/04

(52) U.S. Cl. 373/147; 700/276; 290/40 R

(57) ABSTRACT

A temperature regulation system with an integrated electrical generator is disclosed. In an exemplary embodiment, the temperature regulation system includes a combustion unit for producing heat energy. Further, a blower is in fluid communication with the combustion unit for dispersing air. Additionally, the integrated electrical generator is communicatively coupled to the combustion unit and the blower for providing electrical energy to the blower and the combustion unit. A flue is coupled to the combustion unit for drawing combustion waste products to an exterior environment. Furthermore, an exhaust system is coupled to at least one of the integrated electrical generator and the flue for drawing combustion waste products from the integrated electrical generator to an exterior environment. The integrated electrical generator is configured to provide electricity to the blower and the combustion unit upon interruption of the utility electrical energy supply to the temperature regulation system.

### CROSS REFERENCE

The present application is a continuation under 35 U.S.C. § 120 of U.S. patent application Ser. No. 11/141,264, filed May 31, 2005 which in turn claims the benefit under 35 U.S.C. § 119(e) of U.S. Provisional Application Ser. No. 60/575,352, filed May 28, 2004 which are herein incorporated by reference in their entireties.

### FIELD OF THE INVENTION

The present invention relates to the field of heating, ventilating, and air-conditioning (HVAC) and more particularly to an integrated generator for providing an alternate or back-up power source for operating a heating unit.

### BACKGROUND

Typically, temperature regulation systems such as furnaces operate by combusting natural gas (predominately methane) or propane. Often local utility companies function as suppliers of the natural gas or propane. Due to the high heating value and prevalence of these gases, the majority of furnaces located in cold climates derive their heating capacity from such gases. While the furnace's heating ability is generated by combusting fuels of this nature, typical furnaces include electro-mechanical systems for assisting in combustion or heat distribution. For example, a blower may be employed for distributing air (a forced air system). In addition, the furnace may include electronics for controlling the burners, a thermostat for regulating temperature, and the like. A drawback to this type of furnace is that the furnace will not operate in the event of a loss of electricity. For example, an electronically controlled furnace will not ignite if an electrical power source is not available. Further, heat will not be distributed if electricity is not supplied to the blower, in the case of a forced air system.

Therefore, it would be desirable to provide a temperature regulation system, such as a furnace or an HVAC system, with an integrated generator for producing electricity.

### SUMMARY OF THE INVENTION

Accordingly, the present invention is directed toward a temperature regulation system, such as a furnace, with an integrated electrical generator. As such, the integrated electrical generator provides electricity to the already existing furnace upon interruption of a utility electrical power supply. The integrated electrical generator may be incorporated into the furnace or, in the alternative, be retrofitted into an already existing furnace.

In accordance with a first aspect of the present invention, an integrated electrical generator for providing electrical power energy to a temperature regulation system upon interruption of a utility electrical energy supply to the system is disclosed. In such aspect, the integrated electrical generator includes an alternator to supply energy at multiple voltages. Further, an engine is coupled to the alternator for providing rotational force to the alternator. In addition, a plurality of devices are operationally coupled to the engine for detection of an interruption of a utility electrical energy supply to the temperature regulation system. Moreover, at least one switch is operationally coupled to at least one of the alternator and the engine to operationally control the flow of electricity from the alternator. The integrated electrical generator is configured to provide electricity to a temperature regulation system upon interruption of the utility electrical energy supply to the temperature regulation system.

In accordance with a further aspect of the present invention, a temperature regulation system with an integrated electrical generator is disclosed. In an exemplary embodiment, the temperature regulation system includes a combustion unit for producing heat energy. Further, a blower is in communication with the combustion unit for dispersing air fluid medium. Additionally, the integrated electrical generator is communicatively coupled to the combustion unit and the blower for providing electrical energy to the blower and the combustion unit. A flue is coupled to the combustion unit and engine for drawing combustion waste products to an exterior environment. Furthermore, an exhaust system is coupled to at least one of the integrated electrical generator and the flue for drawing combustion waste products from the integrated electrical generator to an exterior environment. The integrated electrical generator is configured to provide electricity to the blower and the combustion unit upon interruption of the utility electrical energy supply to the temperature regulation system.

In accordance with an additional aspect of the present invention, an additional temperature regulation system is provided which includes a combustion unit for producing heat energy. Further, in such aspect, a blower is in fluid communication with the combustion unit for dispersing air. Moreover, an integrated electrical generator is communicatively coupled to the combustion unit and the blower for providing electrical energy to the blower and the combustion unit, a flue coupled to the combustion unit for drawing combustion waste products to an exterior environment. Additionally, an exhaust system may be coupled to at least one of the integrated electrical generator and the flue for drawing combustion waste products from the integrated electrical generator to an exterior environment. The integrated electrical generator and combustion unit are configured so that they operate from a common fuel supply and exhaust fumes at generally similar temperature ranges.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustration of a furnace in accordance with the present invention, wherein an integrated electrical generator is positioned inside the furnace;

FIG. 2 is an illustration of a furnace, wherein the furnace includes a combustion unit for producing heat, a flue for carrying waste products away from the combustion unit, a blower for dispersing air across the combustion unit and out to an area to be heated, and an exhaust system that couples with the flue for carrying waste products away from the integrated electrical generator;

FIG. 3A is an illustration of an integrated electrical generator in accordance with the present invention, wherein the integrated electrical generator includes a relay switch for sensing when utility power is being supplied to the furnace;

FIG. 3B is an illustration of an integrated electrical generator, wherein the integrated electrical generator includes a transfer switch coupled to a utility power cable for preventing electricity produced by the integrated electrical generator from traveling to an outside circuit, such as the building's electrical system;

FIG. 4A is an illustration of an integrated electrical generator in accordance with an exemplary embodiment of the present invention, wherein the integrated electrical generator includes numerous components which regulate generator activities such as an integrated circuit and a central processing unit;

FIG. 4B is an illustration of an integrated electrical generator in accordance with an exemplary embodiment of the present invention, wherein the integrated electrical generator includes various regulatory components such as a master switch, a gas detector, and a battery pack;

FIG. 5 is a flow diagram illustrating a method by which an integrated electrical generator may be retro-fitted into an already existing furnace; and

FIG. 6 is an illustration of an existing furnace retrofitted with an integrated electrical generator by the method provided in FIG. 5.

### DESCRIPTION OF THE INVENTION

Reference will now be made in detail to the presently preferred embodiments of the invention, examples of which are illustrated in the accompanying drawings.

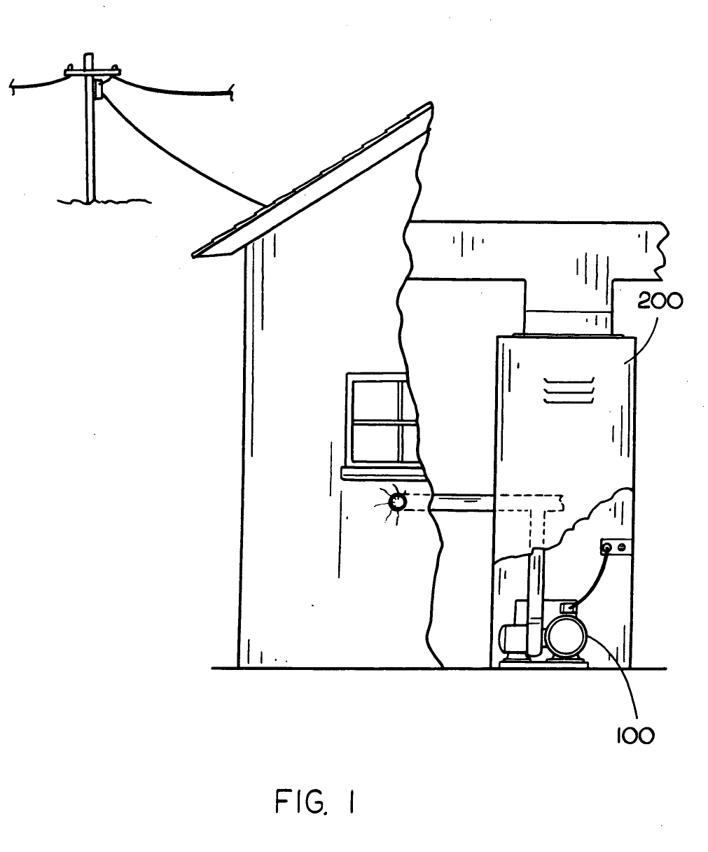

Referring generally to FIGS. 1 through 6, exemplary embodiments of a temperature regulation system equipped with an integrated electrical generator in accordance with the present invention are provided. The instant temperature regulation system is equipped with an integrated electrical generator that allows electricity to be produced when a conventional electrical source is unavailable or has failed. The integrated electrical generator of the present invention may be integrated with a variety of temperature regulation systems such as a furnace, an HVAC system, a heat pump, an air conditioner, or the like. Further, the integrated electrical generator may be disposed within a furnace or retrofitted into a preexisting furnace.

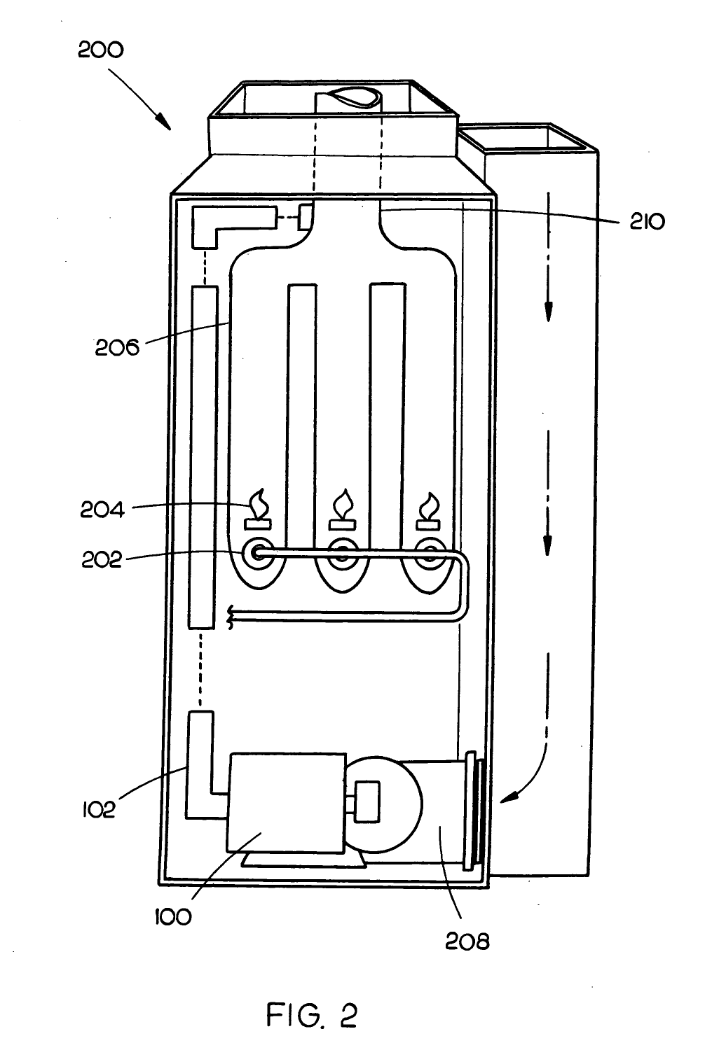

Referring now to FIGS. 1 and 2, in accordance with an embodiment, a furnace 200 includes a combustion unit 202 for producing heat energy. For example, the combustion unit 202 may burn a gas such as propane or natural gas to produce heat. In an exemplary embodiment, the combustion unit 202 is comprised of a system of burners 204 and a heat exchanger 206. In such embodiment, the blower 208 is in fluid communication with the combustion unit 202 so that fresh, non-combustion air may be dispersed throughout the area enclosure being heated. Suitable blowers 208 include a centrifugal fan, an axial fan, and the like. In additional embodiments, a flue 210 is coupled to the combustion unit 202 to draw exhaust gases to an exterior environment. It is contemplated that the flue 210 may include a system of pipes or the like for drawing combusted gases to the exterior of an enclosure/building.

In the present embodiment, as illustrated in FIG. 2, an integrated electrical generator 100 of the present invention is coupled to the flue 210 via an exhaust system 102. In an embodiment, the exhaust system 102 includes a system of pipes. In an advantageous embodiment, the generator engine is formed so that exhaust gas produced by the integrated electrical generator 100 is of substantially the same temperature range as the exhaust gas produced by the furnace 200 such that the HVAC flue piping may be utilized. One method of achieving the desired temperature is by adjusting the amount of fuel burned per unit of oxygen. With exhaust gases of the same temperature range, the flue 210 is able to handle the exhaust gases from the integrated electrical generator 100 without having to be reinforced with a more heat resistant material. In an exemplary embodiment, the exhaust system 102 is constructed of materials which are relatively heat resistant, weather resistant, and cost efficient such as polyvinyl chloride (PVC), galvanized steal, and the like. It is contemplated that standard pipe fittings may be used to couple the exhaust system 102 to the flue 210.

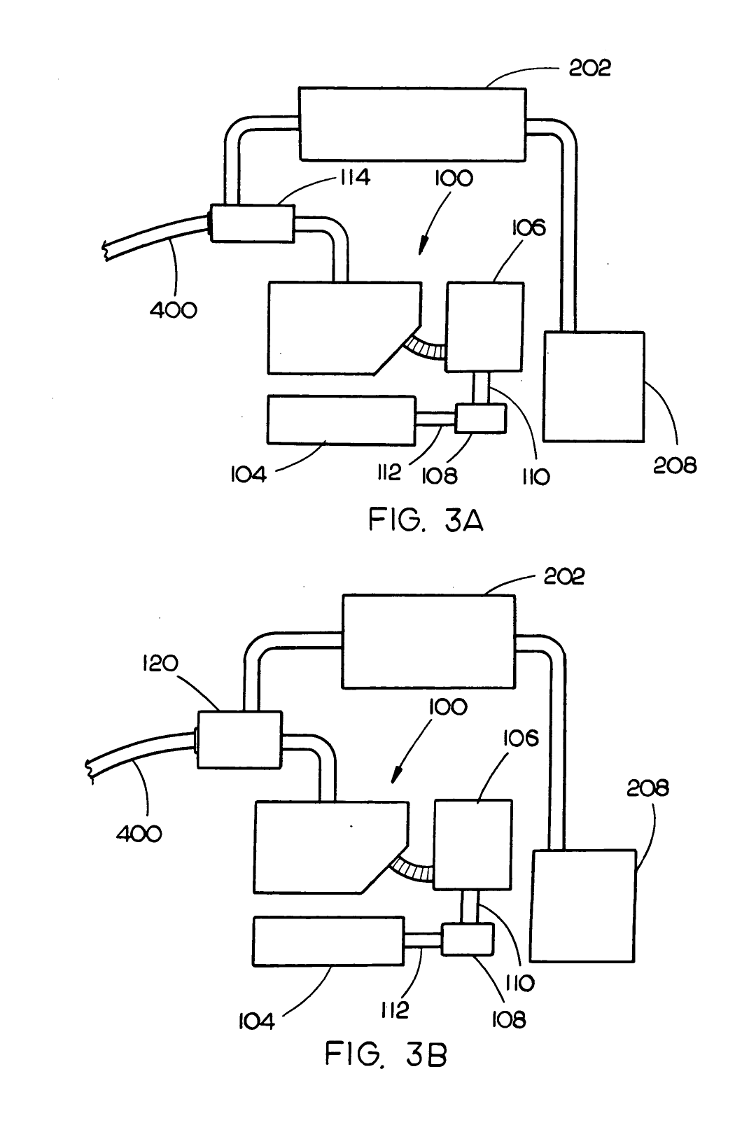

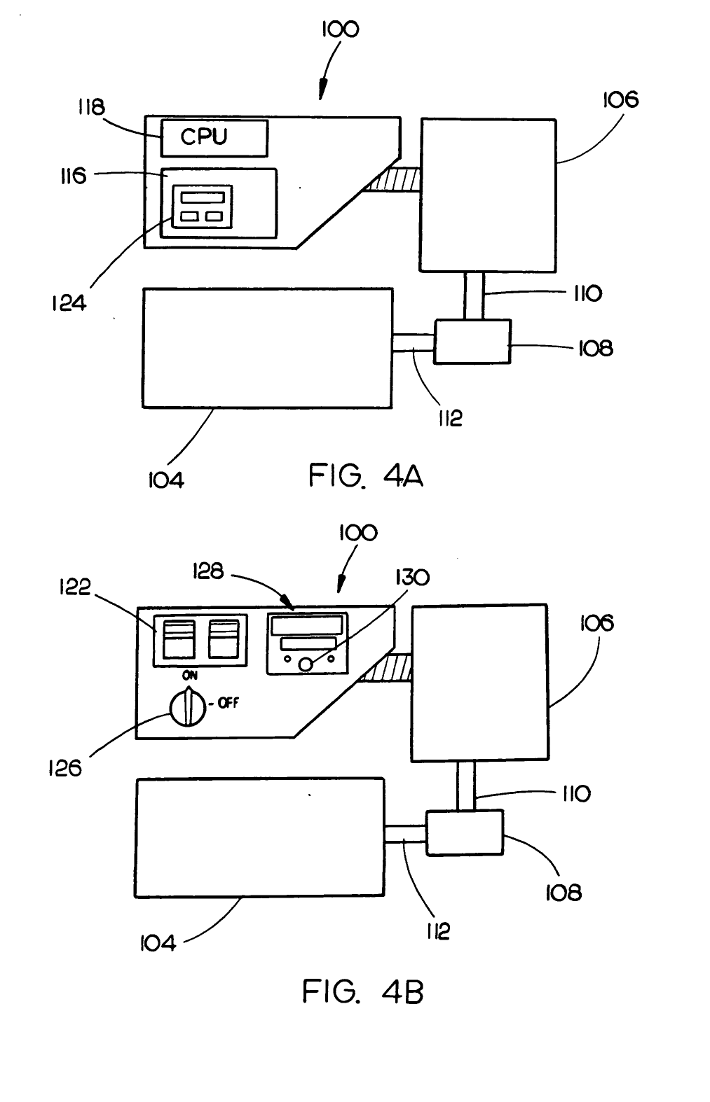

In additional exemplary embodiments, as shown in FIGS. 3A-4B, the integrated electrical generator 100 includes electrical components such as an alternator 104. For example, the alternator 104 may be equipped with an outlet that supplies twelve volts of direct current and another outlet that provides one hundred and twenty volts of alternating current. The twelve-volt output may be used as a supplier of electricity for a variety of operations such as a battery charger, powering a thermostat, or the like. Likewise, the one hundred and twenty-volt output may be used for a variety of operations including the providing power to a blower utilized by the furnace, a window-heating unit, or the like.

In further exemplary embodiments, as illustrated in FIGS. 3A-4B, the integrated electrical generator 100 may also include an engine 106 for providing rotational force to the alternator 104. The engine 106 in the exemplary embodiments is an internal combustion engine. Further, a right-angle drive 108 may be disposed within the integrated electrical generator 100 for coupling a crankshaft 110 of the engine 106 to a crankshaft 112 of the alternator 104. The right angle drive 108 allows the integrated electrical generator 100 to fit into a confined space such as a corner of the furnace 200. In an exemplary embodiment, the right angle drive 108 is comprised of a bevel gear system. In an alternative embodiment, the right angle drive 108 is comprised of a gearbox that houses a worm gear meshed with a spur gear. Both the bevel gear system and the worm gear/spur gear system are suitable for the right angle drive 108 for they allow the plane of rotation to be translated by 90° (ninety degrees).

Referring now specifically to FIG. 3A, additional exemplary embodiments of the integrated electrical generator 100 are shown in which the generator 100 includes a relay switch 114. In such embodiment, the relay switch 114 detects whether electricity is being supplied to the furnace 200 from a standard utility 400. When power returns to the standard utility 400, the relay switch 114 also allows the furnace 200 to resume operation on commercially available power. In other embodiments, the integrated electrical generator 100 employs different devices to detect a loss of power. For instance, in one embodiment, the integrated electrical generator 100 includes a voltmeter and integrated circuit 116 to detect a loss of power (as shown in FIG. 4A). In such instance, the integrated circuit may be hardwired to the voltmeter and be configured to initiate operation of the generator 100 when the voltmeter signals a loss of utility power. In another embodiment, the integrated electrical generator 100 includes a central processing unit 118, illustrated in FIG. 4A, for detecting a power loss. For instance, the central processing unit may be included for monitoring the electrical output of the integrated electrical generator and for terminating the electrical generation in the event of an excess voltage.

As illustrated in FIG. 3B, in addition to being equipped with devices that detect power loss, the integrated electrical generator 100 may be equipped with a transfer switch 120. In such embodiment, the transfer switch 120 prevents electricity produced by the integrated electrical generator 100 from traveling throughout an outside circuit, such as a building's electrical system.

In an exemplary embodiment of the present invention, the integrated electrical generator 100 is capable of sensing when the furnace 200 has been requested to produce heat. Preferably, a hard-wire connection between the integrated electrical generator 100 and a thermostat switch of the furnace 200 enables the integrated electrical generator 100 to detect the request so that the generator 100 may cycle on/off. In other embodiments, various wireless connections may be used such as an RF connection, a blue-tooth connection, an infrared connection, or the like.

As illustrated in FIG. 4A, an exemplary embodiment of the present invention includes a timer 124 coupled to the integrated circuit 116. The timer 124 may initiate routine exercise cycles to identify operability issues. For instance, the timer 124 is set for one month so that the integrated circuit 116 closes the circuit to a starter of the engine 106 and resets the timer 124 when the timer 124 reaches one month. In an alternative embodiment, the central processing unit 118 is coupled to the integrated electrical generator 100 and is programmed to run the routine exercise cycles.

Referring now to FIG. 4B, the integrated electrical generator 100 may be configured to detect when a battery 122 of the integrated electrical generator 100 is in need of charging. The battery 122 is for supplying start-up power to the engine 106. In the preferred embodiment, the integrated electrical generator 100 is equipped with a voltmeter coupled to the integrated circuit 116 to detect low battery levels. In such embodiment, the voltmeter determines how many volts the battery 122 is producing. The integrated circuit 116 is designed to close the circuit from the alternator 104 to the battery 122 when the voltmeter indicates that the battery 122 has dropped below a minimal accepted level for having sufficient energy to cause a starter to operate. Thus, the coupling of the battery 122 to the voltmeter and the integrated circuit 116 reduces, if not eliminates, the possibility that the integrated electrical generator 100 will be without start-up power in the event of a loss of utility power. In another embodiment, the integrated electrical generator 100 is equipped with trickle chargers for continuously charging the battery 122. In yet another embodiment, the central processing unit 118 (as shown in FIG. 4A) detects when the battery 122 is low and, in turn, instructs the alternator 104 to charge the battery 122.

In further exemplary embodiments, the integrated electrical generator 100 may be equipped with devices that prevent the integrated electrical generator 100 from damaging the furnace 200. For instance, as illustrated in FIG. 4B, the integrated electrical generator 100 may include a master switch 126 which acts as a manual override so that users may terminate operation of the integrated electrical generator 100. In an advantageous embodiment, the master switch 126 is positioned in a location where current can be completely restricted from flowing through the integrated electrical generator 100 such as on the electrical power cable running from the integrated electrical generator 100 to the furnace 200. Further, in such embodiment, the integrated electrical generator 100 includes a voltage regulator so that the amount of power delivered to the furnace 200 may be limited.

In additional embodiments, as illustrated in FIG. 4B, the integrated electrical generator may be equipped with a gas detector 128. In an exemplary embodiment, the gas detector 128 detects the ultrasonic sound emitted during gas leaks such as natural gas leaks, propane gas leaks, carbon monoxide leaks, carbon dioxide leaks, and the like. In one embodiment, the gas detector 128 is equipped with an alarm 130 that simply alerts a user when a gas leak has been detected. In an alternative embodiment, the gas leak detector 128 is hardwired to the integrated electrical generator 100 and halts operation upon the detection of a gas leak.

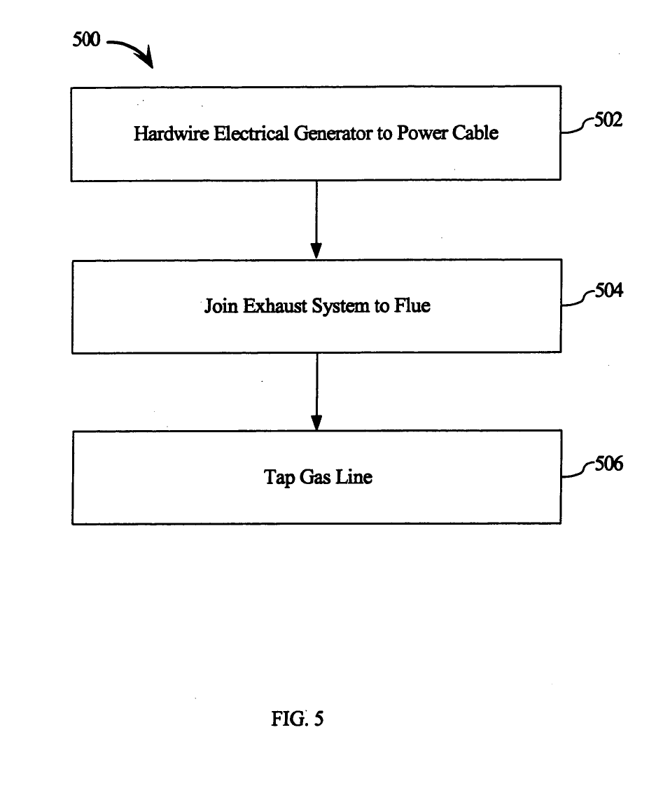

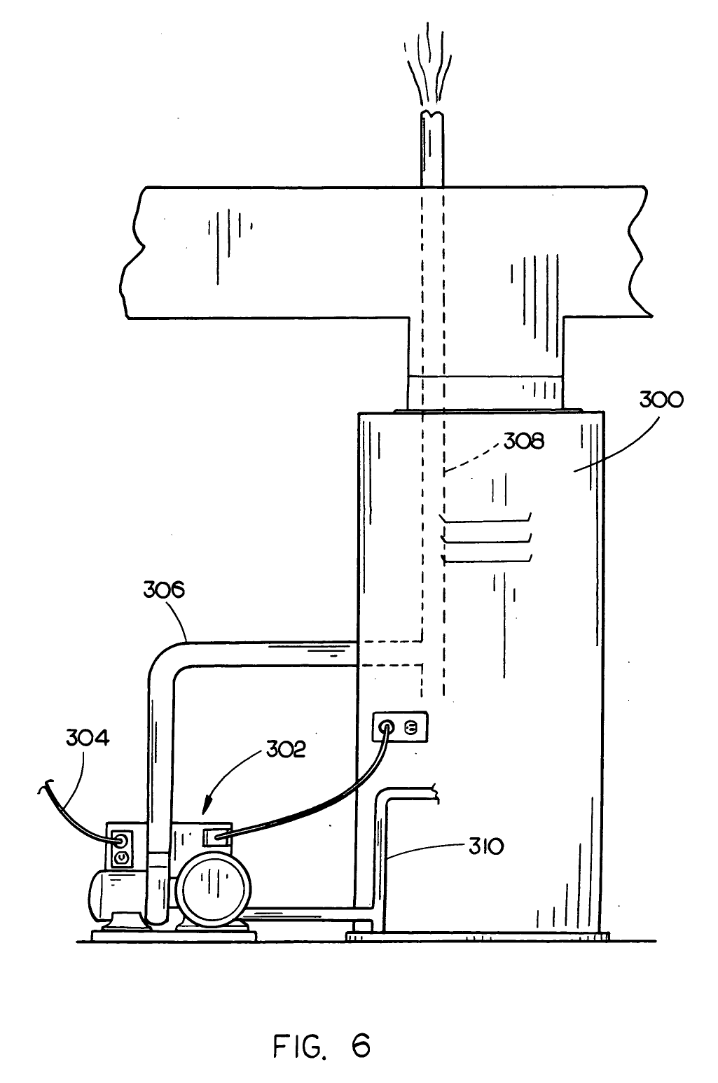

As illustrated in FIGS. 5 and 6, a preexisting furnace 300 may be retrofitted with an electrical generator 302. FIG. 5 provides a flow diagram illustrating a method 500 which may be utilized to retrofit an existing furnace with an electrical generator. A user may hardwire the electrical generator to a power cable 502 that supplies electricity to the furnace. The user may then join an exhaust system of the electrical generator with a flue of the furnace 504 wherein the exhaust gases of the electrical generator are drawn to an exterior environment by the flue. Subsequently, a gas line of the furnace may be tapped 506 wherein the fuel source supplying the furnace may also supply the electrical generator. Upon completion of the retrofit, the electrical generator may then supply electricity to the furnace upon interruption of an alternate power supply, such as an electric utility. A furnace 300 which has been retrofitted with the electrical generator 302 is shown in FIG. 6.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the integrated electrical generator of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof.

What is claimed is:

1. An integrated electrical generator for providing electrical power energy to a temperature regulation system upon interruption of a utility electrical energy supply to the system, comprising:
an alternator to supply energy at multiple voltages;
an engine coupled to the alternator for providing rotational force to the alternator;
a plurality of detection devices operationally coupled to the engine for detection of an interruption in a utility electrical energy supply to the temperature regulation system; and
at least one switch operationally coupled to at least one of the alternator and the engine to operationally control the flow of electricity from the alternator,
wherein the integrated electrical generator is configured to provide electricity to a temperature regulation system upon interruption of a utility electrical energy supply to the temperature regulation system.

2. The integrated electrical generator as claimed in claim 1, wherein the temperature regulation system is a furnace.

3. The integrated electrical generator as claimed in claim 1, wherein the integrated electrical generator and the temperature regulation system operate from a common fuel supply.

4. The integrated electrical generator as claimed in claim 3, wherein the integrated electrical generator is configured to exhaust fumes that are of the same temperature range as the exhaust fumes produced by the temperature regulation system.

5. The integrated electrical generator as claimed in claim 1, wherein the plurality of detection devices for detection of an interruption to a utility electrical energy supply to the temperature regulation system includes a voltmeter and an integrated circuit.

6. The integrated electrical generator as claimed in claim 1, wherein the at least one switch includes a transfer switch for isolating the integrated electrical generator.

7. The integrated electrical generator as claimed in claim 1, wherein the at least one switch includes a relay switch for preventing electricity from being produced by the alternator when electricity is being provided by another source.

8. The integrated electrical generator as claimed in claim 1, further comprising a right angle drive coupled to alternator and the engine for allowing the integrated electrical generator to be placed in a confined space.

9. A temperature regulation system, comprising:
a combustion unit for producing heat energy;
a blower in fluid communication with the combustion unit for dispersing air;
an integrated electrical generator communicatively coupled to the combustion unit and the blower for providing electrical energy to the blower and the combustion unit, a flue coupled to the combustion unit for drawing combustion waste products to an exterior environment; and
an exhaust system coupled to at least one of the integrated electrical generator and the flue for drawing combustion waste products from the integrated electrical generator to an exterior environment,
wherein the integrated electrical generator is configured to provide electricity to the blower and the combustion unit upon interruption of a utility electrical energy supply to the temperature regulation system.

10. The temperature regulation system as claimed in claim 9, wherein the temperature regulation system is a furnace.

11. The temperature regulation system as claimed in claim 9, wherein the integrated electrical generator and combustion unit operate from a common fuel supply.

12. The temperature regulation system as claimed in claim 9, wherein the integrated electrical generator is configured to exhaust fumes that are of the same temperature range as the exhaust fumes produced by the combustion unit.

13. The temperature regulation system as claimed in claim 9, further comprising an integrated circuit for routinely exercising the integrated electrical generator.

14. The temperature regulation system as claimed in claim 9, further comprising a master switch that is manually activated for halting operation of the integrated electrical generator.

15. The temperature regulation system as claimed in claim 9, further comprising a central processing unit for monitoring operability of the integrated electrical generator.

16. The temperature regulation system as claimed in claim 16, wherein the central processing unit is configured for trickle charging.

17. The temperature regulation system as claimed in claim 9, further comprising a right angle drive disposed within the integrated electrical generator for allowing the integrated electrical generator to fit into a confined space.

18. The temperature regulation system as claimed in claim 8, further comprising a transfer switch for isolating the temperature regulation system.

19. The temperature regulation system as claimed in claim 8, further comprising a relay switch for preventing electricity from being produced when electricity is flowing to the combustion unit and the blower from another source.

20. A temperature regulation system, comprising:
a combustion unit for producing heat energy;
a blower in fluid communication with the combustion unit for dispersing air;
an integrated electrical generator communicatively coupled to the combustion unit and the blower for providing electrical energy to the blower and the combustion unit, a flue coupled to the combustion unit for drawing combustion waste products to an exterior environment; and
an exhaust system coupled to at least one of the integrated electrical generator and the flue for drawing combustion waste products from the integrated electrical generator to an exterior environment,
wherein the integrated electrical generator and combustion unit operate from a common fuel supply and exhaust fumes at generally similar temperature ranges.
